(19) United States
(12) Patent Application Publication
(10) Pub. No.: US 2003/0090654 A1
(43) Pub. Date: May 15, 2003

(54) Method and apparatus for evaluating degree of characteristic of a substance

(76) Inventors: Roland Bazin, Bievres (FR); Eric Doublet, Villejuif (FR)

Correspondence Address: Thomas L. Irving, FINNEGAN, HENDERSON, FARABOW,, GARRETT & DUNNER, L.L.P., 1300 I Street, N.W., Washington, DC, 20005-3315, US

(21) Appl. No.: 10/270,002

(22) Filed: Oct. 15, 2002

(30) Foreign Application Priority Data
Oct. 16, 2001 (FR) 01 13325

(51) Int. Cl. B32B 5/02; G01N 21/29

(52) U.S. Cl. 356/317; 356/417; 422/82.05

(57) ABSTRACT

Systems and methods may facilitate evaluation of at least one degree of at least one characteristic of a substance. The systems and methods may generate at least one sequence of images expressing at least one characteristic varying in at least one degree, and receive information reflecting at least one identification of at least one image from the at least one sequence. The at least one image may correspond to at least one degree of at least one characteristic of a substance.

The present invention relates to evaluating at least one characteristic of a substance, such as a characteristic of a cosmetic product or a care product. The characteristic may concern the appearance and the behavior of the substance on being taken up (e.g., conveyed or removed from a substance supply, loaded onto an applicator or portion of a hand, etc.), on being applied, over time, etc.

In the following description, certain aspects and embodiments will become evident. It should be understood that the invention, in its broadest sense, could be practiced without having one or more features of these aspects and embodiments. It should also be understood that these aspects and embodiments are merely exemplary.

One aspect of the invention may include a method of facilitating evaluation of at least one degree of at least one characteristic of a substance. The method may comprise generating at least one sequence of images expressing at least one characteristic varying in at least one degree, and receiving information reflecting at least one identification of at least one image from the at least one sequence. The at least one image may correspond to at least one degree of at least one characteristic of a substance.

Another aspect of the invention may include a method of manufacturing a substance. The method may comprise generating at least one sequence of images expressing at least one characteristic varying in at least one degree, receiving information reflecting at least one identification of at least one image from the at least one sequence, and manufacturing a product expressing the at least one characteristic to the at least one degree corresponding to the at least one image.

Another aspect of the invention may include a method of determining an influence of differing substance formulations. The method may comprise generating at least one sequence of images expressing at least one characteristic of a substance varying in at least one degree, receiving first information reflecting at least one identification of at least one image from the at least one sequence, receiving second information reflecting at least one identification of at least one image from the at least one sequence, and evaluating the influence of the difference in formulation on the at least one characteristic according to at least the first information and the second information. The at least one image reflected by the first information may correspond to at least one degree of at least one characteristic of a first substance. The at least one image reflected by the second information may correspond to at least one degree of at least one characteristic of a second substance. The second substance may have a formulation that is different from that of the first substance.

Yet another aspect of the present invention may include a method of making a visual representation presenting varying gradations of at least one characteristic of a substance. The method may comprise receiving at least first information reflecting at least a starting image, and second information reflecting an end image, generating at least one sequence of intermediate images according to the first information and the second information, receiving at least third information reflecting at least two images from the at least one sequence, and generating, at least partially according to the third information, a visual representation comprising a plurality of images. The starting image and the end image may correspond respectively to differing degrees of at least one characteristic of a substance.

A further aspect of the present invention may include an apparatus for facilitating at least one of viewing and evaluating of at least one degree of at least one characteristic of a substance. The apparatus may comprise a processor configured to generate at least one sequence of images expressing varying gradations of at least one characteristic of a substance.

One aspect of the invention may relate to providing a method for facilitating characterization of a “feel” of a substance or facilitating manufacture or supply of a product that closely matches consumer expectations. This may be done by determining an actual or desired degree of at least one characteristic of a substance. In one aspect of the invention, such a method may comprise generating at least one sequence of images expressing the characteristic to a degree that varies progressively, and within the sequence, identifying at least one image or run of images corresponding to the actual or desired degree of the characteristic.

As used herein, the term “image,” in addition to the ordinary meaning of the term, may include any displayed or projected image in 2D or 3D, or any image that is not displayed, such as an image corresponding to data stored in a memory or on a data recording medium (e.g., a hard disk, an optical disk, etc.). The stored data may be digital data or any other form of data.

As used herein, the term “sequence,” in addition to the ordinary meaning of the term, may include a series of images. The series of images may or may not be viewed together simultaneously.

The images of the sequence may correspond to different degrees of a characteristic that is expressed in varying degrees by the images. For example, the sequence may express the degrees of the characteristic varying in a progression that is continuous, substantially continuous, somewhat continuous, or not continuous.

At least one image of the sequence may be displayed on a screen, but the images of the sequence may also not be displayed on a screen. For example, the images may be printed on paper. The images of the sequence may also not be displayed because they are automatically compared with at least one reference image.

One aspect of the invention may display images of the sequence in such a manner as to create an animated sequence. Another aspect of the invention may selectively display images of the sequence as a function of an action taken by the viewer. Thus, for example, images of the sequence may be displayed as a function of the viewer acting on a cursor of a scroll bar. By way of example, it is also possible to display an image while allowing the viewer to modify at least two characteristics of the substance expressed by the image. The viewer may be enabled to modify the at least two characteristics expressed by said image by acting on two cursors of two scroll bars.

One aspect of the invention may generate data that is representative of the degree of a characteristic of the substance as expressed by an image selected from amongst the images of the sequence. This data may optionally comprise or correspond to a numerical value.

One aspect of the invention may include a method comprising displaying images of a sequence of images at a first geographical location, transferring data representative of a selection made amongst the images of the sequence to a second geographical location and collecting or processing the data gathered at the second geographical location. Another aspect of the invention may involve transmitting the information over a computer network (e.g., an intranet, the Internet, etc.). Yet another aspect of the invention may involve generating a sequence of images in such a manner as to enable a computer system to perform evaluation automatically. The computer system may perform a comparison process between images of the sequence and at least one reference image of a substance that is to be evaluated such that it is possible to determine an actual degree of a characteristic of the substance.

One aspect of the invention may generate the sequence of images by computation. For example, the sequence of images may be generated by means of morphing software or any form of a morphing algorithm using at least one starting image and at least one end image. The starting and end images may correspond to respective different degrees of a characteristic of the substance.

By way of example, the images may be generated as a variable portion superposed on a background. The background may represent a grid or some other backdrop. In one aspect of the invention, the background may represent an image of a surface on which the substance is to be applied. The surface may be a keratinous surface or any other surface. The background may also be selected from amongst a set of predetermined images. The background may be a synthesized image, or it may come from an image acquired by means of a camera, a scanner, or some other image capture device. The image may be an image of a person for whom the substance is intended.

In one aspect of the invention, the sequence may comprise a plurality of sub-sequences arranged end to end. Each sub-sequence may be generated from a respective starting image and end image. The starting image of a sub-sequence of order n may correspond to the end image of a sub-sequence of order n-1. The number of images in a sequence may be greater than or equal to 10, 20, 50, or any other number.

At least one characteristic of the substance, which is expressed to differing degrees in the sequence of images, may be selected. The characteristic may include color, brightness, transparency, texture, rheology, density, or any other quality of the substance. The characteristic may concern the appearance of the substance prior to, during, or after application. The characteristic may concern the aptitude of the substance for being taken up using an applicator, using a finger, by contact, by friction, or any other mechanism. The characteristic may concern the behavior of the substance while it is being applied. The characteristic may also relate to how the substance varies over time (e.g., how long it continues to be effective, etc.).

For example, one aspect of the invention may enable an individual to characterize the “feel” of a substance.

One aspect of the invention may provide a method of manufacturing a product, comprising generating a sequence of images expressing said characteristic to a degree that varies progressively, identifying within the sequence at least one image or a run of images corresponding to the actual and/or desired degree of the characteristic, and manufacturing a product expressing said characteristic to a degree that corresponds to the image or run of images as identified.

For example, one aspect of the invention may enable manufacture or supply of a product that matches consumer expectations closely.

One aspect of the invention may provide a method of determining an influence on a characteristic of a substance due to a modification to a formulation for the substance. The method may comprise generating a sequence of images expressing a characteristic of a substance to a progressively varying degree, identifying within the sequence of images an image or a run of images corresponding to the actual degree of the characteristic in a first substance under test, identifying within the sequence of images an image or a sequence of images corresponding to the actual degree of said characteristic in a second substance under test, and determining the influence of a modification to the formulation relating to the first and second substances on the characteristic. The second substance may have a formulation that is different from that of the first substance under test. The difference between the degrees of the images or runs of images identified for the first and the second substance may be used to determine the effect of the modification to the formulation between the first substance and the second substance.

One aspect of the invention may include a method of manufacturing an atlas. The method may comprise providing at least a starting image and an end image corresponding respectively to different degrees of a characteristic of the substance, generating a sequence of intermediate images between said starting and end images, selecting at least two images from the images of the sequence, and making an atlas comprising a plurality of images as selected in this way. The intermediate images may be generated by means of morphing software. In one aspect of the invention, the selected images may be printed on a single medium or a plurality of mediums.

One aspect of the invention may include an apparatus enabling a degree of a characteristic of a substance to be displayed or determined. The apparatus may comprise a programmed unit for generating a sequence of images expressing varying gradations of a characteristic of a substance. The varying gradations may be a progressive variation of the characteristic of the substance. The apparatus may comprise control means enabling at least one image of the sequence to be selected. The apparatus may comprise at least one screen for displaying images of the sequence. The apparatus may comprise a generator for generating at least one scroll bar and at least one cursor for controlling which image of the sequence to display on a screen. A single image of the sequence may be displayed at any one time. The apparatus may comprise a generator for generating at least two scroll bars with respective associated cursors. Each cursor may serve to control modification of a respective characteristic of the substance as expressed by the displayed image on the screen.

The apparatus may comprise means enabling data representative of a selected image to be sent to a server. The apparatus may comprise a camera or a scanner for acquiring at least one image of a person. The apparatus may comprise means for generating a variable image superposed on a background. The background may be generated from at least one image acquired by a camera, a scanner, or some other image capture device.

The apparatus may comprise means enabling the selection of a degree for a characteristic of the substance to be validated. The apparatus may comprise means for providing an optional digital indication that is representative of the degree of the characteristic of the substance expressed by an image displayed on the screen. The apparatus may comprise a plurality of receptacles containing initial ingredients and a dispenser for dispensing a substance made up of or selected from the initial ingredients, as a function of a selected image.

Other embodiments and aspects of the present invention may include a computer program product or a data storage medium containing instructions to perform any method consistent with the principles and features of the present invention.

Additional embodiments and aspects of the invention are set forth in the detailed description which follows, and in part are obvious from the description, or may be learned by practice of methods, systems, and articles of manufacture consistent with the present invention. It is understood that both the foregoing general description and the following detailed description are exemplary.

The accompanying drawings, which are incorporated in and constitute a part of this specification, illustrate several exemplary aspects of the invention and together with the description, serve to explain some principles of the invention. In the drawings:

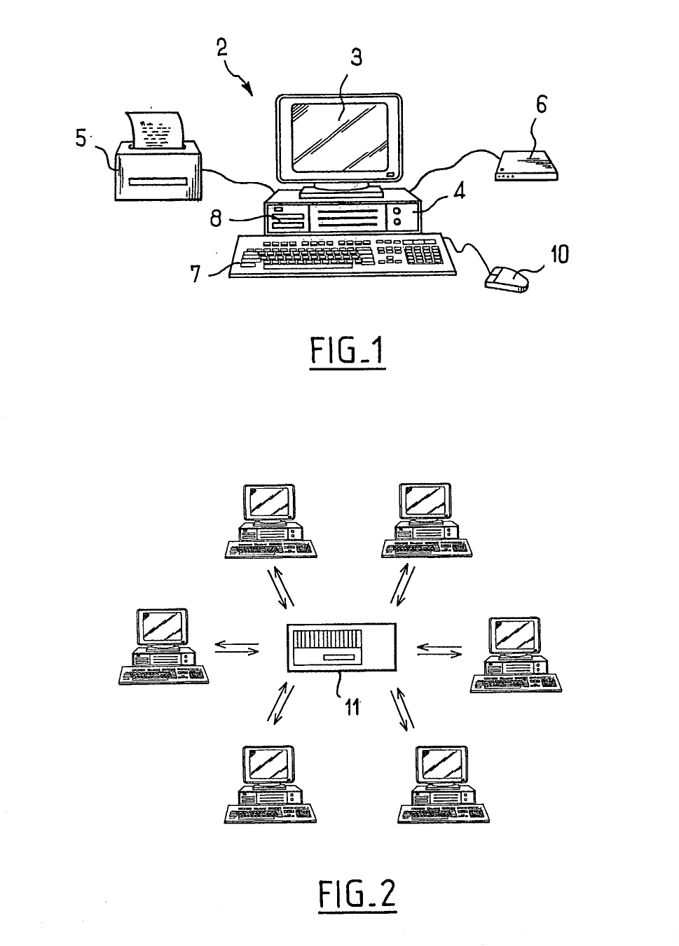

FIG. 1 is an exemplary diagram showing a personal computer, consistent with features and principles of the present invention;

FIG. 2 is an exemplary diagram representing a server connected to a plurality of personal computers, consistent with features and principles of the present invention;

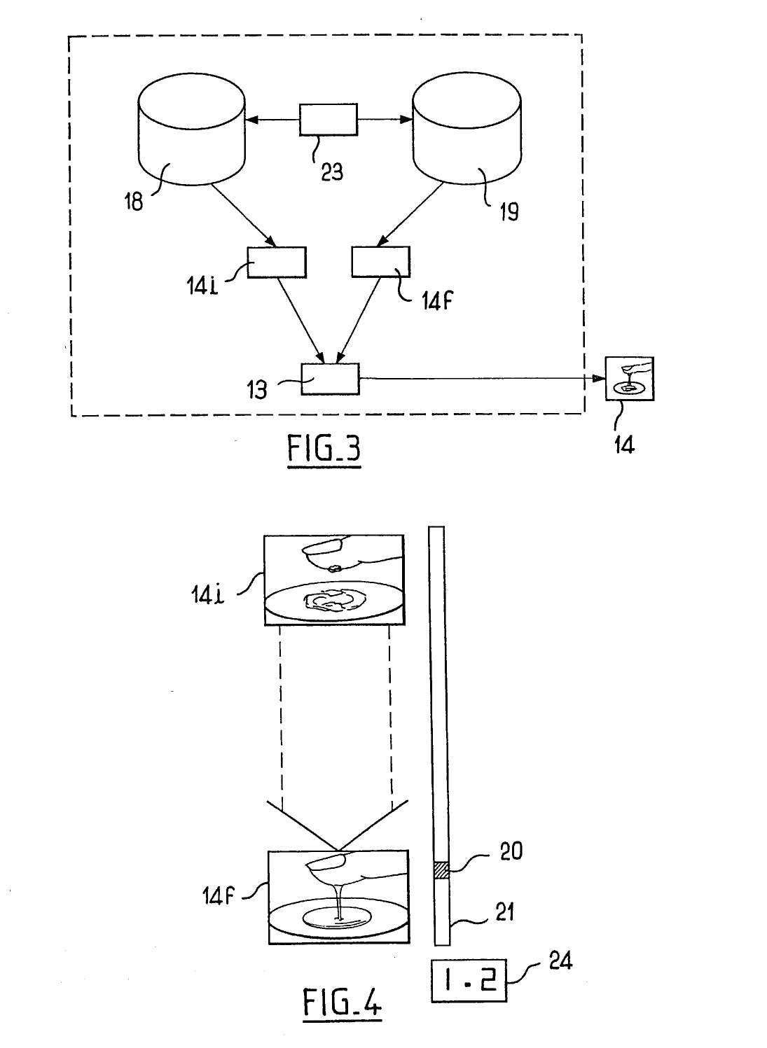

FIG. 3 is an exemplary diagram showing certain aspects of a program, consistent with features and principles of the present invention;

FIG. 4 is an exemplary diagram representative of a sequence of images expressing varying degrees of a characteristic of a substance, consistent with features and principles of the present invention;

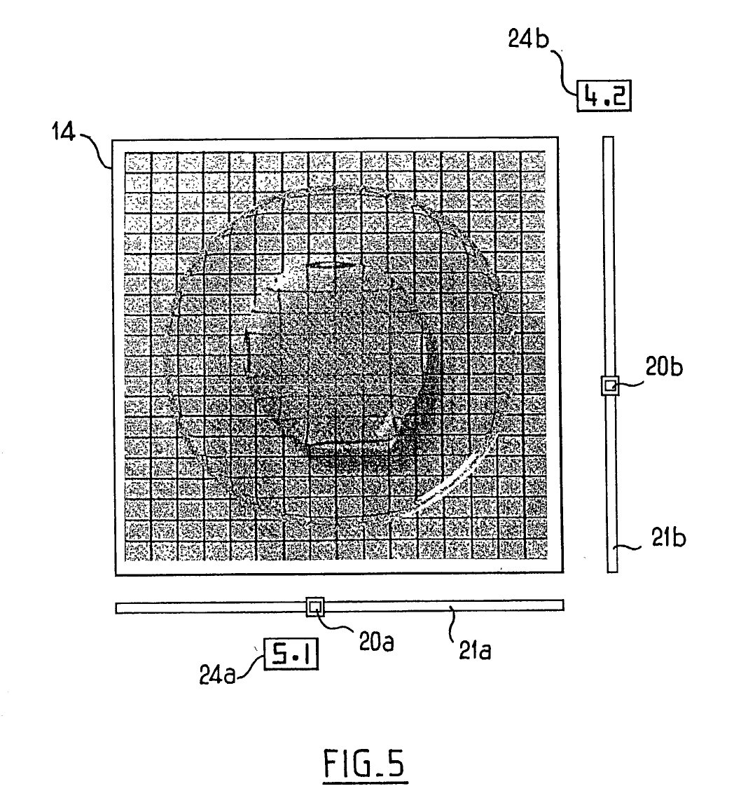

FIG. 5 is an exemplary diagram showing how two characteristics of a substance may be caused to vary by acting on two cursors respectively associated with said characteristics, consistent with features and principles of the present invention;

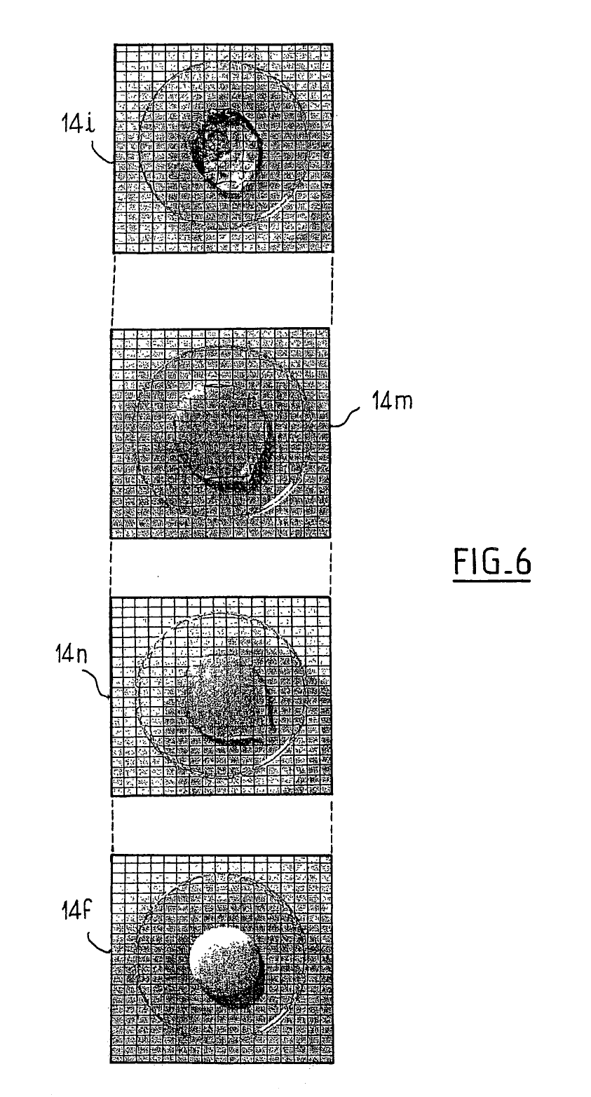

FIG. 6 is an exemplary diagram showing an image sequence comprising a background and a variable portion superposed on the background, consistent with features and principles of the present invention;

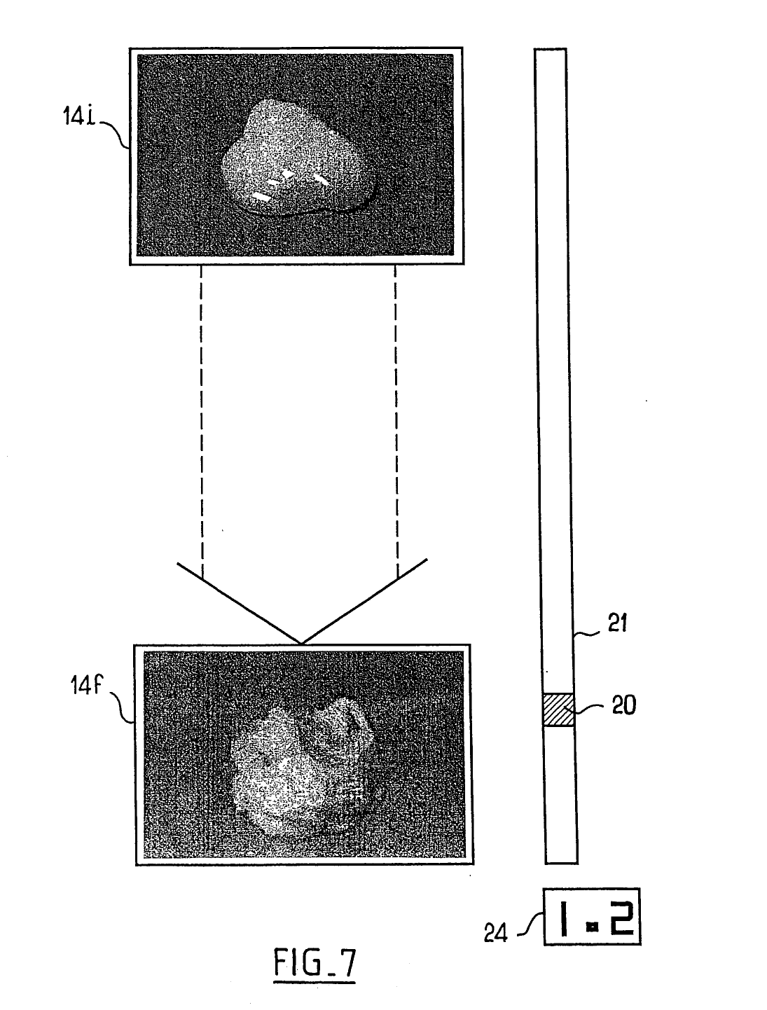

FIGS. 7 to 13 are exemplary diagrams of sequences relating to various characteristics of substances, consistent with features and principles of the present invention;

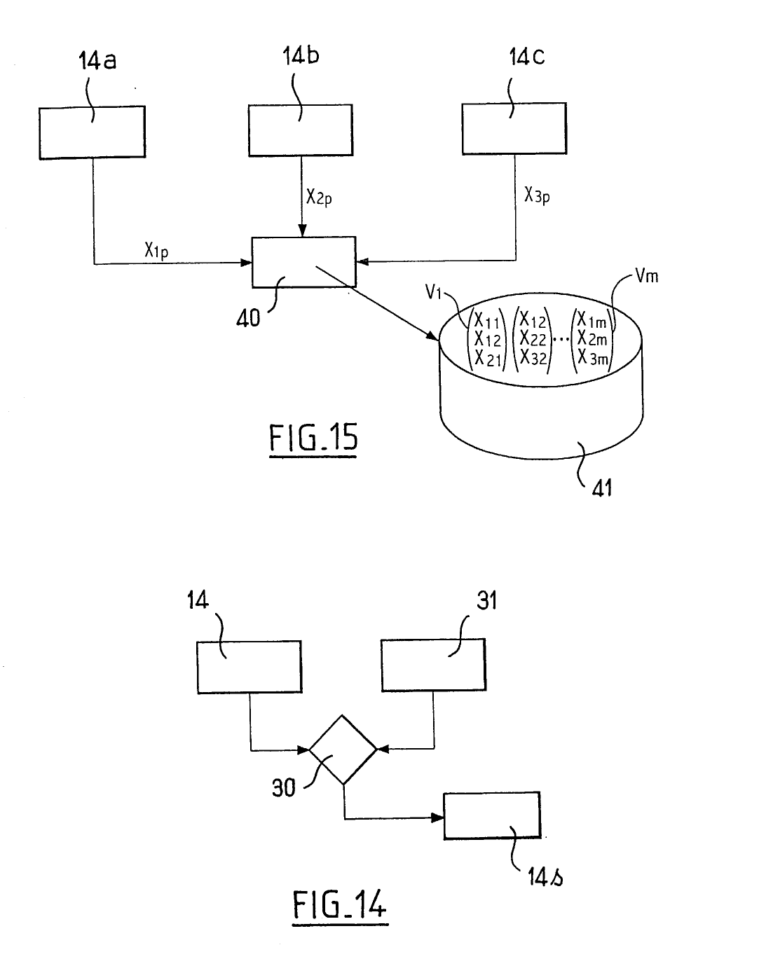

FIG. 14 is an exemplary diagram representative of an image comparison engine, consistent with features and principles of the present invention;

FIG. 15 is an exemplary diagram showing how a multivectorial databank may be built up, consistent with features and principles of the present invention;

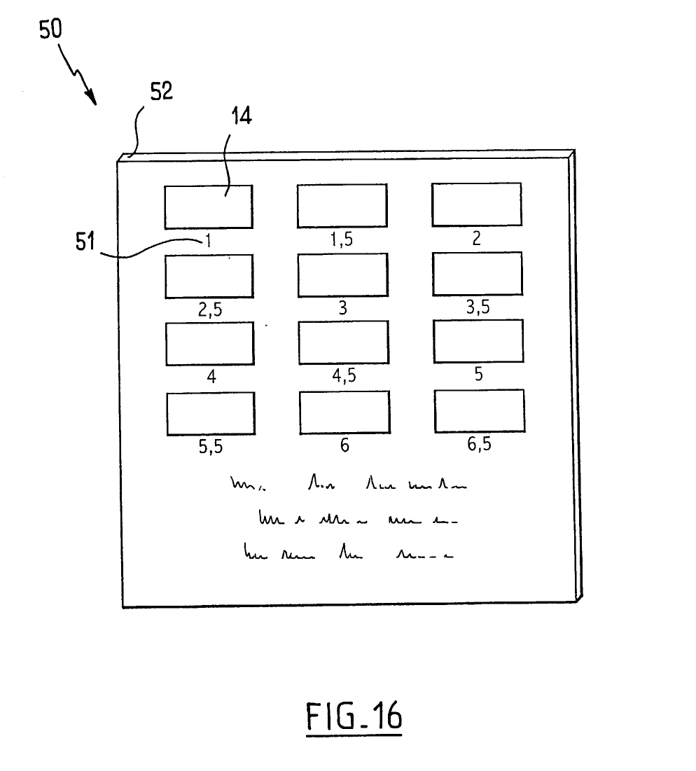

FIG. 16 is an exemplary atlas provided by implementing embodiments consistent with features and principles of the present invention; and

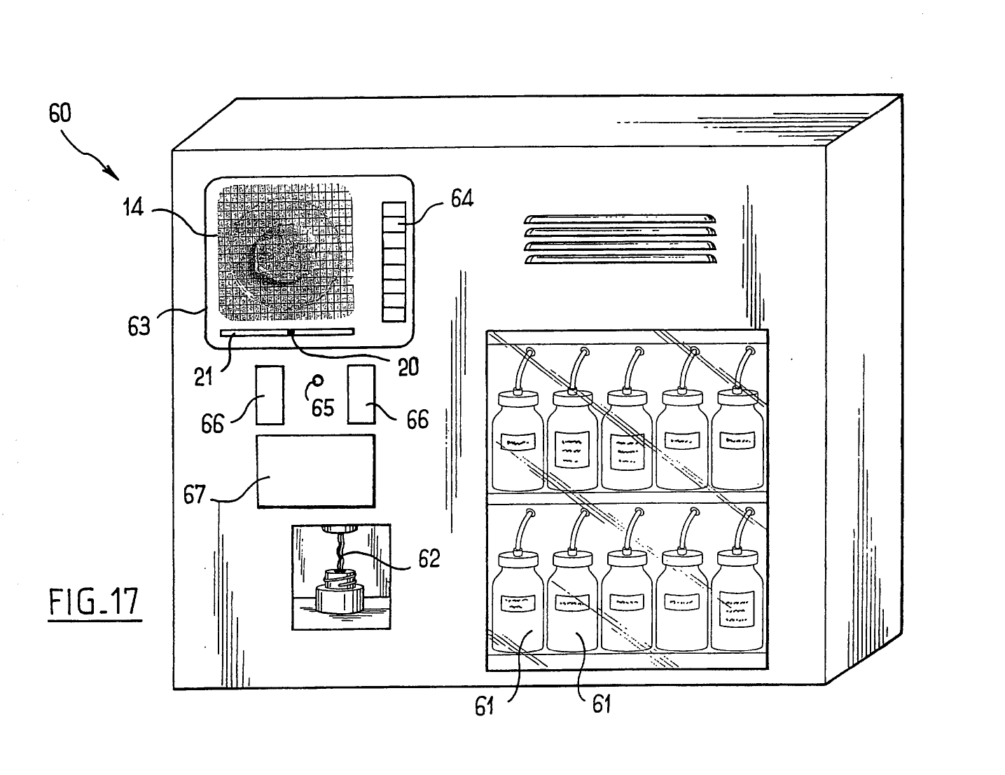

FIG. 17 is an exemplary diagram of an apparatus for supplying a substance having at least one characteristic as selected by a user, consistent with features and principles of the present invention.

Reference is now made in detail to exemplary embodiments of the invention, examples of which are illustrated in the accompanying drawings. Wherever possible, the same reference numbers are used throughout the drawings to refer to the same or like parts.

One embodiment of the invention may be implemented by means of a personal computer. For example, FIG. 1 shows a personal computer 2 comprising a central unit 4 connected to various external peripherals such as a screen 3, a printer 5, a modem 6, a keyboard 7, and a mouse 10. Computer 2 may include a hard disk and floppy drives 8 for reading optical disks and floppy disks. It may be connected to a server 11 over a computer network (e.g., an intranet, the Internet, etc.), as shown in FIG. 2. Computer 2 may be programmed to display a sequence of images on screen 3. The sequence may express varying degrees of a characteristic of a substance, for example, in degrees that vary progressively from one image to the next.

Computer 2 may load a program that includes certain aspects described below with reference to FIG. 3. The program may include an image generator 13 suitable for generating a sequence of images 14 by morphing. Image generator 13 may perform morphing by starting from at least one starting image 14i and terminating with at least one end image 14f. The starting and end images may be from respective databanks 18 and 19.

FIG. 4 is an exemplary diagram showing one example of a sequence expressing varying degrees in the aptitude of a liquid substance for being taken up. The sequence may comprise at least one starting image 14i and at least one end image 14f together with a series of images representing intermediate degrees in the aptitude of the substance for being taken up. The intermediate degrees may be between the degrees shown in the starting and end images 14i and 14f. In the example shown in FIG. 4, the starting image 14i may correspond to the substance being hardly fluid at all and the end image 14f may correspond to the substance being very runny.

Computer 2 may be arranged to cause a sequence of images 14 to be displayed image-by-image on screen 3 while allowing a viewer to freeze on any one image. The viewer may freeze the image by pressing a key on keyboard 7, by clicking on a button of mouse 10, or with other control means (e.g., voice input, a touch-sensitive screen, etc.). A viewer may also run through the images 14 by acting on a cursor 20 of a scroll bar 21, as shown in FIG. 4. Using a position of the cursor 20, the viewer may cause an image of the sequence to be displayed that is nearer or farther from the starting or end images 14i or 14f.

The starting and end images 14i and 14f may be selected from image banks 18 and 19 as a function of information supplied by a selection engine 23. Selection engine 23 may proceed, for example, by causing screen 3 to display one or more questionnaires. The questionnaires may relate to a nature of the substance and the characteristic(s) to be evaluated. As a function of the answers given, selection engine 23 may select starting and end images 14i and 14f from databanks 18 and 19.

The position of cursor 20 on scroll bar 21 may provide information about the degree of the characteristic of the substance corresponding to the displayed image. The position may be identified by means of an alphanumeric display 24 appearing on screen 3. The information may also be transmitted, where appropriate, to the above-mentioned remote server 11. Remote server 11 may remotely process the results of the evaluation. Alphanumeric display 24 may give a score proportional to the number of images 14 in the sequence between the image as displayed or selected on the screen, and starting image 14i or end image 14f. The images that appear on the screen may also be caused to change by a viewer acting on cursors 20a or 20b of respective scroll bars 21a and 21b in FIG. 5. The positions of the cursors may be identified by respective numerical displays 24a and 24b. Viewer action on one of the cursors may cause one of the characteristics of the substance to be varied while viewer action on the other cursor may enable a different characteristic of the substance to be varied.

In one embodiment of the present invention, it may be possible to provide a multiplicity of cursors, or a plurality of control buttons. Each cursor or button may enable the display of at least one characteristic of the substance to be selectively varied. In another embodiment of the present invention, a viewer may cause at least one characteristic of the substance to vary in response to voice commands from the viewer.

Referring back to FIG. 3, image generator 13 may comprise software that computes pixel-by-pixel interpolations between two images. The interpolation may enable a continuous series of intermediate images 14 to be constructed between starting and end images 14i and 14f. Image generator 13 may comprise morphing software that generates intermediate images 14 from starting and end images 14i and 14f. Examples of morphing software may include: WINMORPH V2.1, CINEMORPH 1.2, MPMORPH 4x, TSMORPH 32, FASTMORPHER 1.03, VISONAIRE 1.0, MORPH PLUS 1.04, V-MORPH 2.0, AGA MORPH 2.2, IMAGE MASTER 1.50R, ELASTIC DREAMS 1.01, and FANTASTIC DREAMS. The above-mentioned selection engine 23 and image banks 18 and 19 may constitute portions of such morphing software, where appropriate.

Each image may comprise a background having a variable image superposed thereon, as shown by way of example in FIG. 6. This figure shows a few intermediate images 14m and 14n in a sequence that expresses a characteristic of a substance in a progressive manner (e.g., the transparency of the substance). In the example shown, the background includes a grid and the variable portion of the image shows a drop of substance deposited on a transparent cover partially overlying the grid. The user may visually assess the degree of substance transparency depending on the extent to which the underlying grid is more or less visible. The background may be a synthesized image, or it may be an image acquired by means of a image capture device.

One exemplary embodiment of the invention makes it possible to evaluate a substance (e.g., quantify certain characteristics of the substance). For example, in order to evaluate a substance, a user may run a program in computer 2 to cause an animated sequence to be displayed on the screen, in which only one image is displayed at a time. The sequence may include images in which the degree of a particular characteristic of the substance is caused to vary progressively. While the animated sequence is running on the screen, when a user observes that the displayed image corresponds to the substance that is to be evaluated, the user may interrupt the running of the images by pressing on a key of a keyboard, by pressing on a button of a mouse, or via any other suitable action. The user may load a program which, as mentioned above, can be used to cause an image to be displayed selectively as a function of the position of at least one cursor on a scroll bar. The user may cause the images to vary until a displayed image matches the substance the user is to evaluate.

One exemplary aspect of the invention makes it possible to evaluate appearance characteristics of a substance and also characteristics relating to a behavior of the substance while it is being taken up, while it is being applied, or over time. For example, FIG. 7 shows possible starting and end images in a sequence in which the varying characteristic of the substance is its pearly appearance. A sequence of images may be generated from a starting image 14i, where the substance presents a smooth surface and does not have the iridescent shine of mother-of-pearl, and an end image 14f, where the substance does have the iridescence of mother-of-pearl. In order to evaluate the pearly appearance of a substance, the user may take a knob or sample of the substance in the hand and compare its appearance with that of the images in the sequence. If the sequence is animated, the user may stop the animated sequence on the image which, in the user's opinion, provides the closest match with the substance held in the user's hand. As explained above, the user may also act on a cursor to move through the images, and may determine which image of the sequence corresponds most closely with the appearance of the substance held in the hand by making comparisons.

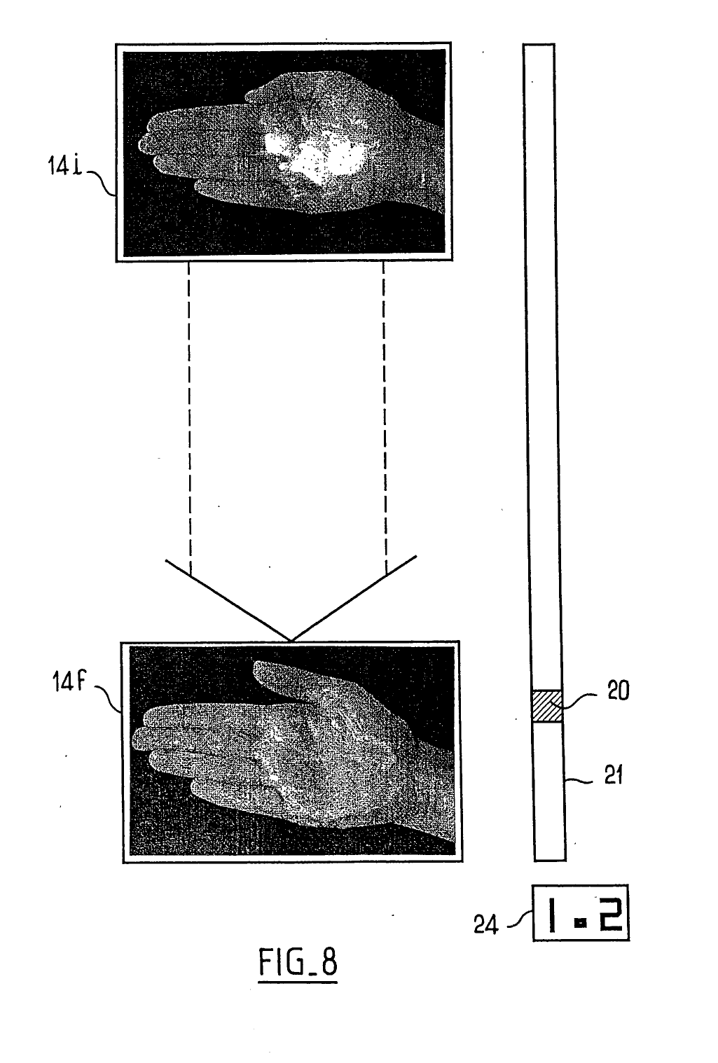

As shown in FIG. 8, it may also be possible to evaluate the ease with which a substance can be mixed with water by comparing the results obtained when attempting to mix the substance with water in the hollow of the hand with the images of a sequence generated from a starting image 14i in which the substance tends not to mix with water and an end image 14f showing the substance thoroughly dispersed in water.

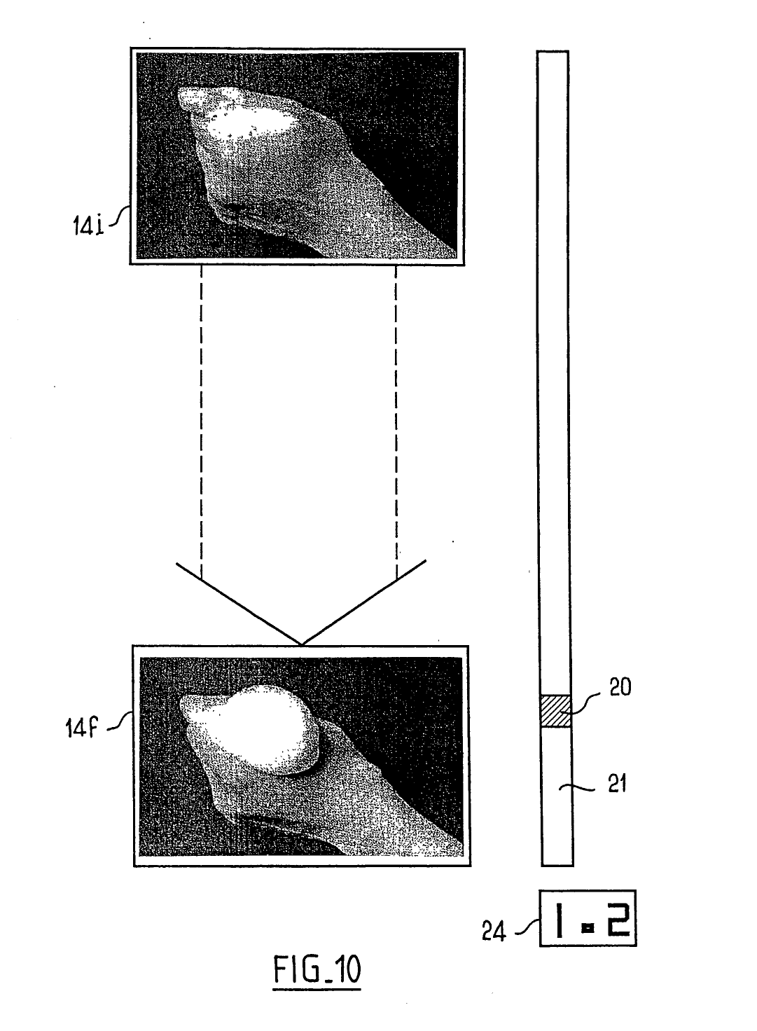

As shown in FIG. 10, it may also be possible to evaluate the extent to which a substance foams. By way of example, the user may make foam in the hollow of a hand and squeeze it by closing the hand. Thereafter, the user may compare the results obtained with images of a sequence comprising a starting image 14i in which the foam hardly spills at all from the hand and an end image 14f in which the foam spills out to a considerable extent.

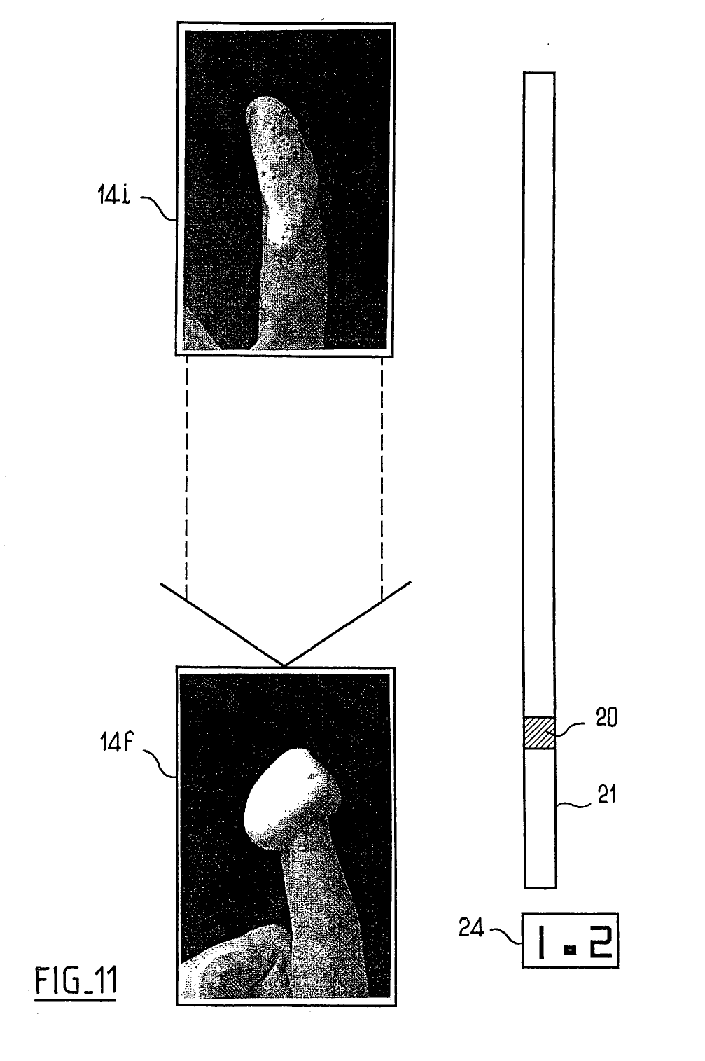

As shown in FIG. 11, the user may evaluate the aptitude of a foam for retaining the shape that is given to it by taking up a small amount of foam on the end of a finger and then observing whether the foam tends to run down the finger or retain its initial shape. By way of example, the user may compare the results obtained with the images in a sequence comprising a starting image 14i in which the foam runs down the finger and an end image 14f in which the foam retains its initial shape.

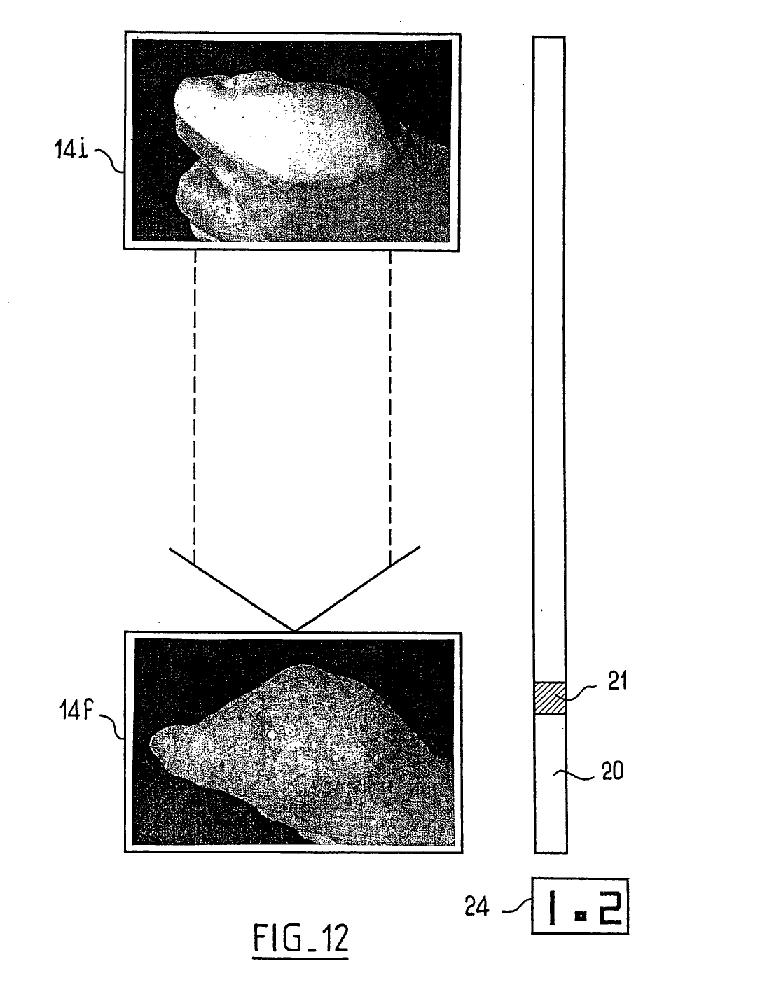

As shown in FIG. 12, it may also be possible to evaluate the size of the bubbles formed in a foam (i.e., the extent to which a substance can be aerated). The user may compare the results of the substance contained in the hand with images in a sequence generated from a starting image 14i in which the substance is aerated to a very small extent and an end image 14f in which the substance is aerated to a very great extent (i.e., forming bubbles that are relatively large).

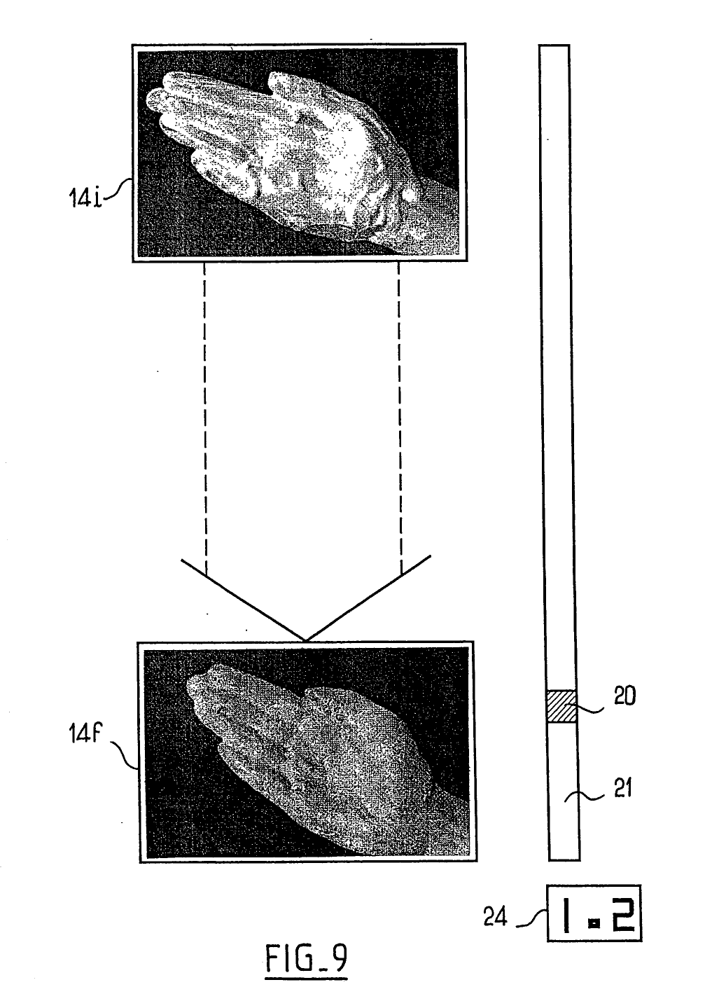

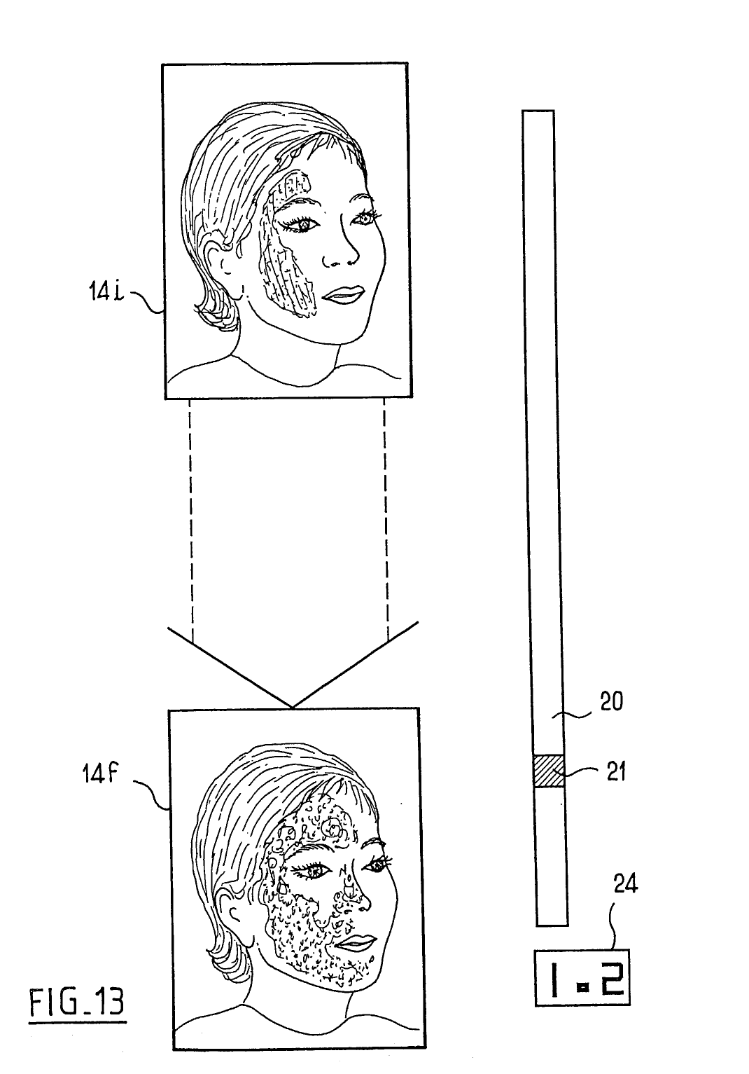

As shown in FIGS. 9 and 13, the user can also evaluate the covering ability of a substance (i.e., its aptitude for hiding the skin of a hand or, in particular, of the face so as to act as a mask). This may enable the user to compare results obtained by spreading a substance on the skin of the hands or face with the images of a sequence generated from a starting image 14i in which the substance has little covering ability and an end image 14f in which the substance has considerable covering ability.

If evaluation is performed by applying the substance to the face, the sequence may show the face of a person other than the user (e.g., a face generated synthetically), or the face of the person who is to perform the evaluation. Under such circumstances, a computer used for generating the sequence may be connected to a image capture device (e.g., a camea, a scanner, or any other capture device) enabling an image of the face of the person who is to perform the evaluation to be acquired, thus making it easier subsequently to compare the results obtained in reality to the images of the sequence. It may also acquire an image of a user in order to make it easier to determine a desired degree of some characteristic of a substance, as described in greater detail below.

The images of the sequence may not necessarily be displayed. For example, they may not be displayed when the images of the sequence are used in a comparison engine 30 of the artificial intelligence type represented diagrammatically in FIG. 14. Comparison engine 30 may automatically evaluate the degree of the characteristic of a substance using the images of the sequence. By way of example, comparison engine 30 may perform comparisons automatically without any need to display an image on a screen. The engine may compare a reference image 31 with images 14 of a sequence in order to select at least one image 14s from the sequence. The image may be selected according to how closely it resembles reference image 31. Once image 14s has been selected, it may be displayed or printed, for example, in order to enable it to be verified by an operator. A score may be calculated according to the number of images in the sequence between selected image 14s and one of the starting and end images 14i and 14f. The score may also be displayed, printed, or transmitted remotely.

One embodiment of the invention may make it possible to build up a multivectorial databank that contains data relating to a plurality of different characteristics of a single substance. For example, FIG. 15 shows a file 40 made up of a plurality of images 14a, 14b, and 14c selected from various image sequences. Each sequence may relate to different appearance characteristics of the substance, such as transparency, brightness, texture, or other qualities.

Images 14a, 14b, and 14c may be selected, for example, by making visual comparisons between the images of the corresponding sequences and the substance to be evaluated, or automatically after acquiring an image of the substance to be evaluated and after using comparison engine 30 to compare it with the images of the sequences. Images 14a, 14b, and 14c for each substance P may be associated with data X₁ₚ, X₂ₚ, and X₃ₚ so as to build up a vector Vₚ in a database 41, as shown in FIG. 15. If a single substance is tested by a panel of people, it may also be possible to build up a databank combining a plurality of vectors, each vector Vₚ having as its components the characteristics of the substance as evaluated by a particular person p.

One embodiment of the invention may also make at least one atlas for evaluating a characteristic of a substance. Such an atlas may be made, for example, by generating a sequence of images from a starting image and an end image corresponding to two different degrees of a characteristic of a substance, and then selecting intermediate images from the sequence between the starting and end images.

All of the selected images 14 may be printed on a single medium 52 so as to make up an atlas 50 as shown in FIG. 16. Each image may be associated with an identifier 51 (e.g., a numerical value expressing quantitatively the degree of that characteristic of the substance as expressed by the associated image). Thus, by way of example, atlas 50 may have at least a dozen images representing varying degrees of a single characteristic of a substance. The atlas may then be used to evaluate given substances for the characteristic in question by comparing the substance being tested with the images in the atlas.

Embodiments of the present invention may be implemented to enable at least one characteristic of a substance under test to be evaluated. One embodiment of the invention may also serve to determine the degree of at least one characteristic of a substance that is desired by a person or a panel of people. This may be done in order to subsequently be able to manufacture a product meeting the expectations of the person or panel. Aspects of the invention thus makes it possible to determine the degree of a characteristic of a product which provides the best match to the expectations of consumers.

Under such circumstances, a panel of people having respective personal computers 2 connected to server 11 (FIGS. 1 and 2) may be asked remotely to select sequence images expressing characteristics of one or more substances that, according to them, best match predetermined criteria. For example, the people may be asked to identify an image representing an appearance or a behavior of the substance that they would like to be able to find in reality. The results obtained may be analyzed to determine, statistically, the particular degree of a characteristic of a substance that is preferred by the people making up the panel. Thereafter, a product may be manufactured while ensuring that it has the characteristic desired by the people making up the panel. It will be understood that such a procedure may make it possible to avoid bringing the people making up the panel together in a single location and also to avoid sending a large number of substances for evaluation out to them. It may also be possible to involve a large number of people independent of their geographical locations.

The invention may also make it possible to provide apparatus capable of dispensing to one particular person a “bespoke” (e.g., custom-made) product that presents a selected characteristic. By way of example, FIG. 17 shows apparatus 60 capable of being installed on sale premises. Apparatus 60 may contain a plurality of receptacles 61 with respective ingredients suitable for making up a cosmetic or care product 62 suitable for dispensing by apparatus 60. Apparatus 60 may have a touch-sensitive screen 63 for displaying an image 14 of a sequence and various control buttons 64 (e.g., a cursor 20 and a scroll bar 21). Apparatus 60 may have a camera 65 placed between two striplights 66 and a mirror 67 enabling users to see themselves. Apparatus 60 may be programmed to enable a user to modify a characteristic of a substance that is to be applied to the face (e.g., a covering ability of said substance, etc.).

The user may select an image 14 by acting on cursor 20 in order to modify the characteristic in question. After selecting an image or a run of images from the sequence, the user may cause the apparatus 60 to dispense a product 62 having the selected degree of the corresponding characteristic. Image 14 displayed on the screen 63 may be an image made up from an image of the user as acquired by means of the camera 65 so as to enable the user to assess a characteristic of the substance more easily (e.g., its covering ability). Under such circumstances, the user may cause the displayed image to vary so as to determine the covering power of substance 62. The substance may then be made by mixing ingredients or it can merely be selected from a plurality of ingredients stored in apparatus 60.

The following claims are hereby incorporated into this description, with each claim standing on its own as a separate embodiment of the invention. Further, as used herein, the term “or” is used in both a conjunctive and a disjunctive sense, as appropriate.

It will be apparent to those skilled in the art that various modifications and variations can be made to the structure and methodology of the present invention. Thus, it should be understood that the invention is not limited to the examples discussed in the specification. Rather, the present invention is intended to cover modifications and variations.

What is claimed is:

1. A method of facilitating evaluation of at least one degree of at least one characteristic of a substance, the method comprising:
generating at least one sequence of images expressing at least one characteristic varying in at least one degree; and
receiving information reflecting at least one identification of at least one image from the at least one sequence, wherein the at least one image corresponds to at least one degree of at least one characteristic of a substance.

2. A method according to claim 1, further comprising:
determining, at least partially according to the received information, at least one actual degree of the at least one characteristic of the substance.

3. A method according to claim 1, further comprising:
determining, at least partially according to the received information, at least one desired degree of the at least one characteristic of the substance.

4. A method according to claim 1, wherein the at least one sequence of images expresses the at least one characteristic progressively varying in the at least one degree.

5. A method according to claim 1, wherein the at least one identification of at least one image from the at least one sequence is at least one identification of at least one series of images from the at least one sequence.

6. A method according to claim 1, wherein the at least one identification of at least one image from the at least one sequence is at least one identification of a run of images from the at least one sequence.

7. A method according to claim 1, wherein the at least one image of the sequence is present on at least one printed medium.

8. A method according to claim 1, further comprising:
transmitting at least one image of the at least one sequence via a network.

9. A method according to claim 8, wherein the network is at least one of a computer network and a telephone network.

10. A method according to claim 8, wherein the computer network is an Internet.

11. A method according to claim 1, further comprising:
displaying at least one image of the at least one sequence.

12. A method according to claim 1, wherein none of the images of the at least one sequence is displayed.

13. A method according to claim 1, further comprising:
displaying at least part of the at least one sequence as an animated sequence.

14. A method according to claim 1, further comprising:
receiving information reflecting an instruction; and
displaying at least one part of the at least one sequence according to the information reflecting the instruction.

15. A method according to claim 14, wherein the instruction reflects cursor information of a scroll bar and wherein the at least one part of the at least one sequence is displayed at least partially according to the cursor information.

16. A method according to claim 1, further comprising:
generating, at least partially according to the received information, data representative of the at least one degree of the at least one characteristic of the substance.

17. A method according to claim 16, wherein the data comprises a numerical value.

18. A method according to claim 16, wherein the data comprises a non-numerical value.

19. A method according to claim 1, further comprising:
displaying at least part of the at least one sequence of images at a first location;
transferring data representative of at least part of the received information to a second location; and
processing the data at the second location.

20. A method according to claim 1, further comprising:
evaluating at least one actual degree of the at least one characteristic of the substance by, at least in part, comparing at least one image of the at least one sequence with at least one reference image of the substance.

21. A method according to claim 20, wherein a computer performs at least part of the evaluation.

22. A method according to claim 1, wherein the at least one sequence of images is generated by computation.

23. A method according to claim 1, wherein the at least one sequence of images is at least partially generated using at least one starting image and at least one end image, wherein the starting image and the end image correspond respectively to different degrees of the at least one characteristic of the substance.

24. A method according to claim 23, wherein the at least one sequence of images is at least partially generated using morphing software on the starting image and the ending image.

25. A method according to claim 1, wherein the images in the at least one sequence comprise a variable portion superposed on a background.

26. A method according to claim 25, wherein the background represents a grid.

27. A method according to claim 25, wherein the background represents an image of a surface onto which the substance is to be applied.

28. A method according to claim 25, wherein the background is selected from a set of predetermined images.

29. A method according to claim 25, wherein the background is a synthetically generated image.

30. A method according to claim 25, wherein the background comes from an image acquired by an image capture device.

31. A method according to claim 30, wherein the image capture device is at least one of a camera and a scanner.

32. A method according to claim 30, wherein the image acquired by the image capture device is an image of a person.

33. A method according to claim 32, wherein the person is to receive a substance having the at least one characteristic to the at least one degree reflected in the received information.

34. A method according to claim 1, wherein the at least one sequence comprises a plurality of sub-sequences in series.

35. A method according to claim 34, wherein each sub-sequence is generated from a starting image and an end image.

36. A method according to claim 35, wherein a starting image of an n^{th} sub-sequence in the series corresponds to an end image of an (n-1)^{th} sub-sequence in the series.

37. A method according to claim 1, further comprising:
displaying at least one image in the at least one sequence; and
receiving information reflecting at least two characteristics of the substance as expressed by the at least one displayed image.

38. A method according to claim 37, further comprising:
enabling a user to modify the at least two characteristics of the substance as expressed by the at least one displayed image.

39. A method according to claim 38, wherein the user is enabled to modify the at least two characteristics of the substance as expressed by the image via two cursors of two scroll bars.

40. A method according to claim 1, wherein the at least one sequence comprises at least 10 images.

41. A method according to claim 1, wherein the at least one sequence comprises at least 20 images.

42. A method according to claim 1, wherein the at least one sequence comprises at least 50 images.

43. A method according to claim 1, wherein the at least one characteristic of the substance is at least one of color, brightness, transparency, texture, rheology, and density.

44. A method according to claim 1, wherein the at least one characteristic of the substance relates to an appearance of the substance.

45. A method according to claim 1, wherein the substance may be applied and the at least one characteristic of the substance relates to an appearance of the substance prior to application.

46. A method according to claim 1, wherein the at least one characteristic of the substance relates to the aptitude of the substance for being taken up.

47. A method according to claim 1, wherein the at least one characteristic of the substance relates to a behavior of the substance while the substance is being applied.

48. A method according to claim 1, wherein the at least one characteristic of the substance relates to a way the substance varies over time.

49. A method of manufacturing a substance, comprising:
performing the method according to claim 1; and
manufacturing a product expressing the at least one characteristic to the at least one degree corresponding to the at least one image.

50. A method of determining an influence of differing substance formulations, the method comprising:
generating at least one sequence of images expressing at least one characteristic of a substance varying in at least one degree;
receiving first information reflecting at least one identification of at least one image from the at least one sequence, wherein the at least one image reflected by the first information corresponds to at least one degree of at least one characteristic of a first substance;
receiving second information reflecting at least one identification of at least one image from the at least one sequence, wherein the at least one image reflected by the second information corresponds to at least one degree of at least one characteristic of a second substance, wherein the second substance has a formulation that is different from that of the first substance; and
evaluating the influence of the difference in formulation on the at least one characteristic according to at least the first information and the second information.

51. A method of making a visual representation presenting varying gradations of at least one characteristic of a substance, the method comprising:
receiving at least first information reflecting at least a starting image, and second information reflecting an end image, wherein the starting image and the end image correspond respectively to differing degrees of at least one characteristic of a substance;
generating at least one sequence of intermediate images according to the first information and the second information;
receiving at least third information reflecting at least two images from the at least one sequence; and
generating, at least partially according to the third information, a visual representation comprising a plurality of images.

52. A method according to claim 51, wherein the visual representation is at least one of an atlas, a chart, and a graph.

53. A method according to claim 51, wherein the at least two images from the at least one sequence are present on at least one printed medium.

54. A method according to claim 53, wherein the at least two images from the at least one sequence are present on a common printed medium.

55. An apparatus for facilitating at least one of viewing and evaluating of at least one degree of at least one characteristic of a substance, the apparatus comprising:
a processor configured to generate at least one sequence of images expressing varying gradations of at least one characteristic of a substance.

56. Apparatus according to claim 55, wherein the varying gradations vary progressively.

57. Apparatus according to claim 55, further comprising a selector for enabling selection of at least one image of the at least one sequence.

58. Apparatus according to claim 55, further comprising at least one screen for displaying at least one image of the at least one sequence.

59. Apparatus according to claim 57, further comprising a generator for generating at least one scroll bar with a cursor for controlling which image of the at least one sequence to display on a screen, wherein a single image of the at least one sequence is displayed at any one time.

60. Apparatus according to claim 55, further comprising means for enabling data representative of a selected image to be sent to a server.

61. Apparatus according to claim 55, further comprising:
an image capture device for acquiring at least one image of a person; and
means for generating a variable image superposed on a background, wherein the background is generated from at least one image acquired by the image capture device.

62. Apparatus according to claim 61, wherein the image capture device is at least one of a camera and a scanner.

63. Apparatus according to claim 61, wherein the background does not vary.

64. Apparatus according to claim 55, further comprising means for enabling a selected degree of at least one characteristic of the substance to be validated.

65. Apparatus according to claim 58, further comprising an indicator for providing an indication representative of at least one degree of the at least one characteristic of the substance as expressed by the image displayed on the screen.

66. Apparatus according to claim 58, further comprising a generator for generating at least two scroll bars with two respective cursors, each cursor controlling at least one modification of a respective characteristic of the substance expressed by the at least one displayed image.

67. A device comprising:
the apparatus of claim 57; and
a dispenser associated with the apparatus, the dispenser being configured to dispense a substance produced from initial ingredients as a function of the at least one selected image.

68. The device according to claim 67, wherein the dispenser comprises at least one of a formulating portion configured to formulate the dispensed substance from the initial ingredients and a selection means for selecting the dispensed substance.

69. The device of claim 67, further comprising a plurality of containers containing the initial ingredients.

70. A method of facilitating evaluation of at least one degree of at least one characteristic of a substance, the method comprising:
receiving at least one sequence of images expressing at least one characteristic varying in at least one degree; and
providing information reflecting at least one identification of at least one image from the at least one sequence, wherein the at least one image corresponds to at least one degree of at least one characteristic of a substance.

71. A method of determining an influence of differing substance formulations, the method comprising:
receiving at least one sequence of images expressing at least one characteristic of a substance varying in at least one degree;
providing first information reflecting at least one identification of at least one image from the at least one sequence, wherein the at least one image reflected by the first information corresponds to at least one degree of at least one characteristic of a first substance; and
providing second information reflecting at least one identification of at least one image from the at least one sequence, wherein the at least one image reflected by the second information corresponds to at least one degree of at least one characteristic of a second substance, wherein the second substance has a formulation that is different from that of the first substance, and
wherein the first information and the second information are provided for evaluating, according to at least the first information and the second information, the influence of the difference in formulation on the at least one characteristic.

72. A computer product configured to perform the method of claim 1.

73. A data storage device containing instructions to perform the method of claim 1.

74. A computer product configured to perform the method of claim 50.

75. A data storage device containing instructions to perform the method of claim 50.

76. A computer product configured to perform the method of claim 51.

77. A data storage device containing instructions to perform the method of claim 51.

78. A computer product configured to perform the method of claim 70.

79. A data storage device containing instructions to perform the method of claim 70.

80. A computer product configured to perform the method of claim 71.

81. A data storage device containing instructions to perform the method of claim 71.
